(19) United States
(12) Patent Application Publication
(10) Pub. No.: US 2023/0118743 A1
(43) Pub. Date: Apr. 20, 2023

(54) METHOD AND SYSTEM FOR MANAGING PARKING SPACE AVAILABILITY

(71) Applicant: Yash Patel, Cupertino, CA (US)

(72) Inventor: Yash Patel, Cupertino, CA (US)

(21) Appl. No.: 17/503,326

(22) Filed: Oct. 17, 2021

(51) Int. Cl. G06Q 10/02

(52) U.S. Cl. CPC G06Q 10/02; G06Q 2240/00

(57) ABSTRACT

A system and method for car parking reservations and booking system is described according to some embodiments. The method and system include a platform for a non-commercial host to host their driveway or private garage for a renter to park their car. The platform acts as a marketplace for parking spot renters and hosts to securely reserve, park, ad monitor the car while its parked. The system uses machine learning and artificial intelligence to determine parking patterns and make parking spot suggestions to renters. The system also determines parking spot conditions and provides them to the user or the parking spot. The system may also obtain a plurality of parking spot conditions and locale parameters, such as a walking score and neighborhood security, and make them available to the user.

### FIELD OF THE INVENTION

The invention relates to managing parking availability in a variety of locations by detecting vehicles and communicating availability to users in a network.

### DISCUSSION OF THE RELATED ART

Parking availability is a common problem in cities and popular locations. Prices vary in the different parking garages. A driver has no idea what the prices are, or if a price is the best one available for a desired location. Many times, the driver does not even know a space is available at the location. Lack of information can cause frustration and lost time to people looking to park and find a parking location close to their destination. Lost revenue for businesses also may occur as people get frustrated and leave the location.

Other frustrations may occur trying to park on the street or where meters are used. Most of these places have no central management or even a way to inform a driver that a spot is available. Moreover, a driver cannot even know where a parking spot is along a street.

Further, drivers would like to access this information on a mobile device in real-time. Drivers also would like to reserve parking spots so that they have a place to park when they arrive at the locations.

### SUMMARY OF THE INVENTION

A platform creates sales tasks to be performed by a sales person when engaging prospects. The sales tasks are prioritized according to engagement by the prospect. Metrics based on activity by the prospect are combined to determine an engagement score. Based on the engagement score, follow up engagement sales tasks are recommended to the sales person.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a system for managing parking availability according to the disclosed embodiments.

FIG. 2 illustrates a parking spot along with associated components according to the disclosed embodiments.

FIG. 3 illustrates a flowchart for booking a parking spot according to the disclosed embodiments.

FIG. 4 illustrates a flowchart for making a parking spot available according to the disclosed embodiments.

FIG. 5 illustrates a flowchart for using a parking spot according to the disclosed embodiments.

FIG. 6 illustrates a flowchart for alerting a host of unauthorized parking according to the disclosed embodiments.

FIG. 7 illustrates a flowchart for making a parking spot available using information from a vehicle according to the disclosed embodiments.

FIG. 8 illustrates a system for managing parking availability according to the disclosed embodiments.

FIG. 9 shows a generalized embodiment of a user equipment device 900, in accordance with one embodiment.

FIG. 10 illustrates a parking spot with a lock box according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

The disclosed embodiments relate to methods and systems to manage parking locations. The following disclosure refers to a driver, but also may be used by a user, passenger, or anyone to obtain information and manage parking locations. The disclosed embodiments also may help businesses manage their locations and optimize use of the parking locations.

A driver may use an application on a mobile device or a computer to find authorized parking spots on the go. The driver may put in the destination to which he or she is travelling in a search function of the disclosed application and view all of the available parking spots in that area or location related to the destination. The driver can even view the nearest landmarks, differentiate between public, commercial, and residential parking. Examples may be bus stops, metro stations, buildings, schools, offices, parks, stores, and the like. The application also may determine an estimated time of arrival to provide to the driver to the destination as well as anyone managing the parking locations.

The driver also may pre-book the spot, if allowed. The driver may start the parking meter within the application to record the time that he or she has parked the vehicle by scanning a graphical code, such as a QR code, present at the parking facility. The driver may extend the booking if the parking spot is still available after the parking period expires. The driver also may view the details of the parking location, such as type (covered/uncovered), amenities, valet parking, description of the appearance of the location, parking levels, guidelines, operation hours, and the like. Ratings for the parking location also may be available for viewing.

If the parking location is used after hours, then the driver may drop the key in an electric box if the parking location is a residential or hotel/motel lot. This allows use of the parking location so that, in case of an emergency, the host or owner of the residential lot may remove the key from the highly secured electric box and remove the vehicle from the parking spot to avoid destruction to the vehicle. The driver may view the parked vehicle locations once it is parked using the application. A pin may be dropped in the location in the application.

Another component of the system may be a host side. A host may be a residential owner, unused piece of land owner, office space owner, public facility, and the like that uses the disclosed system and application to rent out the parking locations for drivers looking to park their vehicles. Thus, in additional to commercial garages and lots, people not in the professional parking business may use the system and application to rent their spots on a variable basis. A host may list a parking space on the application and generate income with it.

A host may start renting the space once a proof of ownership is uploaded and reviewed. Proof of ownership verifies that the host can rent out the space. The host, once approved, can rent the parking space. The host may decide to choose a plan that he or she can decide the amount of time to rent the spot, and any other parameters to make available to potential drivers. Preferred payment methods also may be specified. The host may decide whether to rent the spot daily, weekly, monthly, and so on. The host can create multiple plans for different locations.

The host also may add a bank to directly receive the revenue that is generated by the parking spots on a periodic basis. In other words, periodic deposits may be made from revenue collected on renting the parking spots as determined by the application. The host also may view revenues as it accumulates.

The host side of the disclosed system also may allow the host to accept or decline parking booking requests. Hosts may choose to go online or offline with plans to make the parking locations visible to potential drivers. The host's parking space may be visible only on the availability map if the host has marked the space online within the application. Various interfaces may be used to allow hosts to mark and unmark their spaces. A driver may be able to view the availability in real time.

The host can report unauthorized occupancy of the parking lot and even request for removal of the vehicle within the application. This feature may be especially important for hosts using on street parking or parking spots at residential locations. The host also can view the status of progress of parking spots submitted for renting using the application. Drivers also may provide ratings for the spaces and parking lots using the application. Hosts may view these ratings and act accordingly.

Residential hosts may access the electric box in case of an emergency or unforeseen situation. Further, if a driver booked a spot for a given period of time and he or she does not extend the period of time. The vehicle remains in the spot. The host may access the electric box as well as remove the vehicle.

Hosts also may rate drivers and note when problems occur with an interaction. For example, a driver may own a vehicle that leaks or other mechanical problems that result in problems after using the parking spot. Hosts also may report damage to the area near or in the parking spot.

Hosts also may use the application having a dashboard via the web to view whether their personal or commercial space is vacant or occupied. A wireless sensor and data collector is installed in the parking spot to monitor status. Information from the sensor is used to let the host know whether the spot is occupied. The host may view this status using the application.

A host may contact a driver by using messages, calls, and the like. For maintaining security, the contact numbers of the host and driver on either side may be masked. Drivers may rent a spot directly using the application using different payment methods. Hosts can receive payments directly to their accounts that are linked to the application.

The process may be summarized below. A driver looking for spots can view available parking spots using the application. The driver selects a spot using the availability map. An address may be provided to the driver and imported into a map application to provide directions to the driver. The driver, as soon as he or she reaches the parking destination, can scan the QR code at the parking spot to start the parking meter. If the driver pre-booked the parking spot, then the driver can scan the QR code to check in. In some locations with multiple spots, the QR codes may be at a kiosk or entrance instead of being at the spot.

A host has the option to decline the booking request of the driver in the case of residential parking. Maybe the host inaccurately posted availability of the parking spot or someone from the residence is parking in the spot.

The driver can put the keys to the vehicle into a secure electric box at the parking lot or spot. This feature also may be available at a residential location with the box being located in a driveway. Instructions to operate the electric box may be provided through the communication channel of the application to maintain security. Use of the electric box is not mandatory, but encouraged. The driver may stop the parking meter and pay using the application. The drop box may allow both user and the host to access a key deposited in the lockbox based on a variety of options, such as fingerprinting recognition, locking and unlocking using Wifi signal of received from a mobile phone, features that deploy Artificial Intelligence (AI) to detect based on certain parameters to be provided by the person intending to access the lock box. The lock boxes may also include camera that provide a live video feed upon access or a live vide feed is activated based on a user detection or motion detection to alert the parties involved (host and user) that the lock box is being accessed. In some instances an authorization may be needed that the system may send to the user or host as a push notification that can be approved to allow access.

A sensor system may be used to monitor usage of the parking spots. A wireless parking detection sensor installed in each parking spot or commercial lot detects the parking spot being occupied or vacant. The sensor reports in real time. The real time data may be directly viewed by the driver looking for spots and hosts displaying the spots within the application. A dashboard may be used for web-based applications. The capability helps in detecting unauthorized occupancy and providing security of the lots.

A vehicle enters a parking lot with the sensor or sensors installed. The sensor detects the occupancy of the parking spot and sends data to the data collector at the facility. The data collector and sensor are connected to a router by means of Internet or wireless network connectivity. This information is sent real time to a communication server, which in turn sends this information to a central server so that the information is synced with a database. The information is shown real time on all applications or dashboards.

If marked yes by any of the actors within the system, then notifications are sent through the application. A parking location may be marked valid or invalid depending upon the data of that particular location. For example, information such as “Parking on this street is not allowed on Mondays- Watch out! — in case a driver parks there on Mondays.” Other notifications may include “Parking time expiring” at 15 minutes before reaching the end of the time period, new parking requests for hosts, occupancy status for lots, coupons or parking specials, and the like.

In some embodiments, parking may be short term or long term, depending on the host. Alternatively, the system is connected to the car parking spot owner's, or host's, navigation system. In one example, the host is currently in the parking spot, which is located in San Francisco. The host types into his car's GPS or navigation system information for a destination in Los Angeles. The GPS shows the time of travel is 5 hours and to minutes. The disclosed system then recognizes that the hose will be away for a minimum of 11 hours (5.5 hours for the trip each way). The disclosed system may open the parking spot for booking by drivers for the next 11 hours. The sensor detects when the vehicle departs the parking spot. The system also may provide alerts to the host to approve the 11 hour open slot of booking.

The host can edit as needed, such as if he or she knows a family member needs the spot for 5 hours. The host may add items like going to a basketball game or movie in Oakland. The system will calculate both driving and event time to determine a total time to make the parking spot available for booking.

In some embodiments, the system can sync with the host's calendar. If the host is travelling somewhere, especially for an extended period, or has a meeting, then the system can review the travel or meeting time to open the parking spot for booking. For example, if the host is taking a flight to Chicago and his return trip is two days later, then the system will read this information from the calendar to open the parking spot for the duration that the host is away.

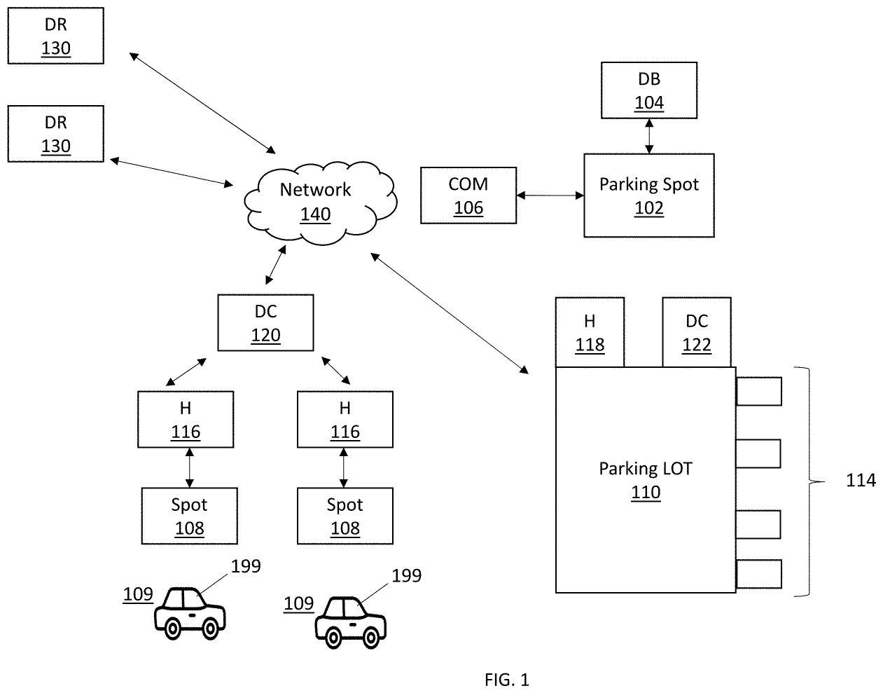

FIG. 1 depicts a system 100 for managing parking availability according to the disclosed embodiments. System 100 provides real time information about parking spots 108 and parking lot 110 to drivers 130. This information may be collected by parking server 102 and analyzed to provide it to drivers 130. Although referred to as “drivers,” the following description uses this terms to indicate mobile platforms, computers, or other devices that receive information, preferably over a network 140. Network 140 may refer to the internet or other network having nodes and communication protocols to communication information.

Parking server 102 and database 104 may form the central portion of system 100. Data is collected and sent to these devices to update availability information, respond to requests, process payments, update accounts, and the like. Parking server 102 may be connected to communication server 106. Communication server 106 may receive communications from devices within network 100. Communication server 106 may then process the communications prior to updating parking server 102. Further, such a configuration may allow for a layer of security such that parking server 102 is not directly accessible over network 100.

Parking spots 108 may refer to residential or non-commercial parking spots. Such spots may be in driveways, on the street, in a development, or any spot that is owned or controlled by a host 116. Again, host 116 refers to a computing device used by the actual host. Preferably, host 116 is a mobile device. Each parking spot 108 includes a sensor 112. Sensor 112 is dedicated to the spot so that it includes a unique identification code that matches to the parking spot with parking server 102. Sensor 112 communicates in real time to data collector 120. Data collector 120 then communicates the sensor update information to communication server 106.

Parking lot 110 may refer to a location having multiple parking spots, such as a commercial lot or garage. Host 118 controls the operations of parking lot 110. Host 118 may not necessarily be a mobile device, but a computer located in the office for the parking lot. An attendant may review the computer and provide information for system 100. Parking lot 110 includes sensors 114 for the multiple parking spots that provide availability information. Sensors 114 provide this information to data collector 122, which then provide it to communications server 106.

Different data collectors may be used within network 100. Data collectors 108 may be placed in various locations, such as within an urban area with many residential, private, or single parking spots 112. For example, a data collector 108 may be located on each city block. In another example, a host may serve as a data collector for a location for extra compensation. Data collector 122, however, is dedicated to a commercial parking lot. Thus, data collector 122 may just receive information for a dedicated location, smaller than locations associated with data collector 120. Data collector 122 may be a device located within the parking lot office.

Parking spots 108 also may be associated with vehicles 109. Vehicle 109 may normally park in spot 108. Parking spot 108 becomes available when vehicle 109 is away. Vehicle 109 also may include navigation system 199 to provide information on the location of the vehicle. Parking lot 110 also may have vehicles dedicated to specific or reserved spots, though individual spots “owned” by a host may rented to drivers like parking spots 108.

Drivers 130 query parking server 102 for availability of parking spots 108 and parking lot 110. Parking server 102 uses the real time information provided by sensors 112 and 114 to show the availability of spots. This information may be provided to a mobile device or a component within the vehicle for driver 130. Drivers 130 may select and reserve a parking spot using an application that communicates with parking server 102. This process is disclosed in greater detail below.

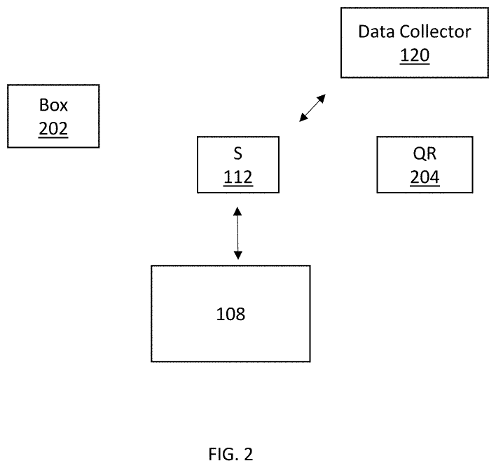

FIG. 2 depicts a parking spot 108 along with associated components according to the disclosed embodiments. Each parking spot has a sensor 112 that monitors the availability of the spot and sends this information periodically to data collector 120. For example, sensor 112 may send every 5 minutes during day time hours when parking is in demand and every 30 minutes during night time hours when parking is not in demand (this situation may be reversed for some locations). Sensor 112 may send a signal to detect an object, such as a vehicle, in parking spot 108. Sensor 112 also may be a pressure sensor, or pressure sensors, on parking spot 108. In other embodiments, sensor 112 may not activate until told so by system 100.

Parking spot 108 also may include electric box 202. A driver of a vehicle using parking spot 108 may place their keys or other ignition/lock enabling device into box 202. This allows host 116 to move the vehicle or otherwise access it. Electric box 202 may be accessed using a code provided to driver 130. Driver 130 punches in the code and places the items into the box. Host 116 may have their own code to access the box.

Parking spot 108 also may have a QR code 204 located near the location so that driver 130 can scan the code. This may be used to provide information to parking server 102. It also may be used to provide driver 130 with information about the availability of parking spot 108. QR code 204 may be placed on a pole, sign, and the like near the parking spot. The QR code also may direct the driver to a page to leave comments regarding the parking spot. Other codes may be used.

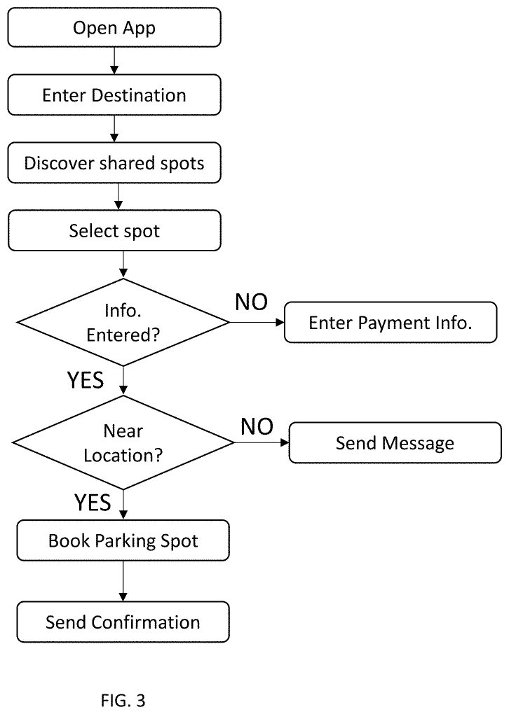

FIG. 3 illustrates a flowchart 300 for booking a parking spot according to the disclosed embodiments. The process shown in flowchart 300 may be used by a driver 130 to reserve, or “book,” a parking spot 108 or 110 using an application. The application may execute on a mobile device or computer used by the driver. As noted above, “driver” 130 refers to such a device. The application launches and converts the device into a parking spot reservation machine. The driver can view and reserve parking spots via the application, which sends and receives data over a network.

Step 302 executes by opening the application on the device. The application provides a graphical user interface (GUI) to allow the driver to interact with the application. Step 304 executes by entering the destination of driver 130. This step may be accomplished in several ways. One may be entering the location information into the application. Alternatively, the application may retrieve GPS coordinates or other location information from the device itself. The application sends a request to the map or location application for the needed information. In some embodiments, the application may connect to a wireless network to obtain location information.

Step 306 executes by discovering shared parking spots using the application. The application queries registered available parking spots on server 102. The application sends a request with the location information. Server 102 sends back the available parking spots, which are displayed on the device or computer. Driver 130 may set the area around the location to display. For example, a default area for showing available parking spots may be a city block. Alternatively, the application may show 10-15 parking spots no matter how large the area to encompass all spots.

Step 308 executes by driver 130 selecting the parking spot from the available spots. The driver may simply press an icon that brings up information about the available spot, which as address, price, available times, and the like. The driver may press a button to confirm a reservation. Step 310 executes by determining whether payment information has been entered for the driver. The application automatically secures payment from the driver before reserving the spot from the host. If step 310 is no, then step 312 executes by prompting the driver to enter payment information, such as a credit card, bank routing information, PayPal™ account, and the like.

If step 310 is yes, then step 314 executes by determining whether the driver is near to the desired location of the selected parking spot. The application does not want to reserve spots for drivers that are not within a reasonable driving distance. For example, if the driver is not within a 5-10 minutes drive time to the parking spot, then he or she cannot reserve it. This prevents spots from going unused or preventing drivers closer to the spot from reserving it. The application may execute an algorithm to determine which driver can reserve a spot when there are multiple requests.

If step 314 is no, then step 316 executes by sending a message to the driver that the spot is not available because of being too far away. If step 314 is yes, then step 318 executes by booking the parking spot using the application. Step 320 executes by receiving confirmation for the reservation. The confirmation may be sent via text, email, or through the application.

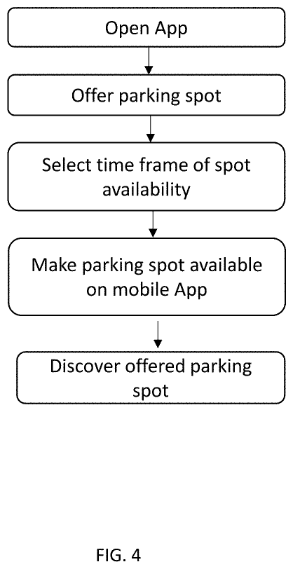

FIG. 4 illustrates a flowchart 400 for making a parking spot available according to the disclosed embodiments. The process disclosed by flowchart 400 relates to a host 116 or 118 uploading the availability for a parking spot for reservation by a driver. The information for the parking spot is sent to server 102 to be added to any requests received by drivers 130.

Step 402 executes by opening the application on host 116 or 118. As noted above, “host” may refer to a mobile device or computer that supports the application. Step 404 executes by offering the spot using the GUI in the application to input information for the location, size, price, available times, and the like for the parking spot. The host inputs the information and it is forwarded to server 102. The server updates its records for the location.

Step 406 executes by selecting the times that the parking spot is available. This information also is sent to server 102. Step 408 executes by making the information for the parking spot available over the application. Step 410 executes by a driver discovering the offered spot via the application.

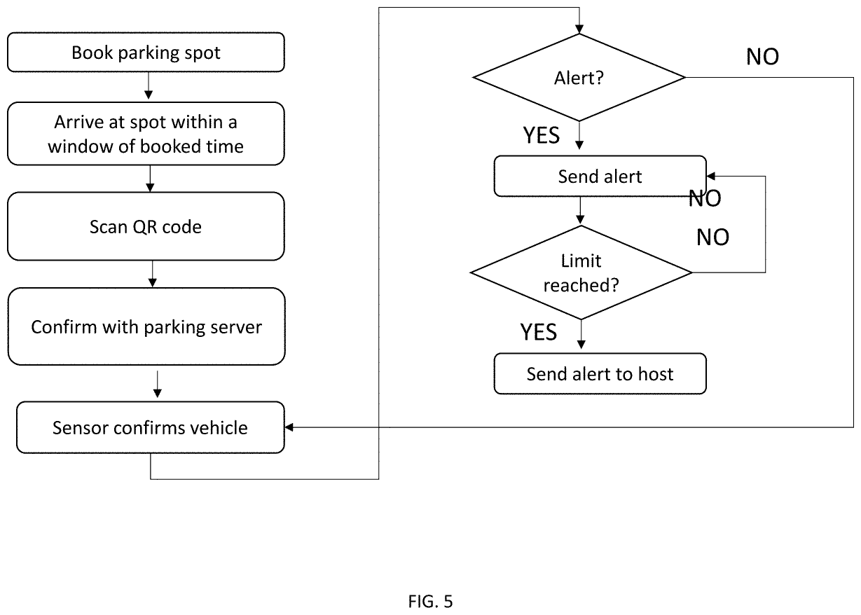

FIG. 5 illustrates a flowchart 500 for using a parking spot according to the disclosed embodiments. The process disclosed by flowcharts relates to the steps taken by a driver when using a parking spot to register the use and confirm arrival and departure times. Step 502 executes by booking, or reserving, a parking spot108 or 110 using the application by a driver 130. Step 504 executes by arriving at the parking spot within the time limit by the application. As disclosed above, the driver should arrive at the spot within the time limit or it is placed back on the application as available.

Step 506 executes by scanning QR code 204. This action alerts server 102 that the driver has located and acknowledged using the parking spot. QR code 204 directs the application to send the information. Step 508 confirms this information with server 102 based on the mobile device or computer hosting the application. For example, each device may have an IP address that is used by server 102 to track driver 130. The IP address is sent with the reservation and then confirmed in step 508.

Step 510 executes by sensor 112 or 114 confirming that a vehicle occupies parking spot 108 or 110. Server 102, after confirmation, may instruct sensor 112 or 114 to detect the presence of the vehicle. Sensor 102 also may photograph information about the vehicle, such a license plate.

Step 512 executes by determining whether an alert should be sent based on the information collected by sensor 112 or 114. For example, if the wrong vehicle parks in parking spot 108, then an alert should be sent. Other situations may include if the vehicle is not detectable by the sensor. Maybe the driver parked in the wrong space. If yes, then step 514 executes by sending the alert to the host and server 102. An alert also may be sent to the driver or local law enforcement authorities. If step 512 is no, then flowchart 500 returns to step 510 to continuously confirm the presence of the vehicle at specified intervals.

Step 516 executes by determining whether the time limit has been reached for the reserved time by driver 130. Server 102 may send a command to the sensor for the parking spot to determine whether the vehicle is still in the spot. Server 102 may count down the termination of the reserved time period by sending alerts to the driver. If yes, then step 518 executes by sending an alert to the host that the vehicle is still in the parking spot. The host then may take action. If step 516 is no, then flowchart 500 returns to step 512.

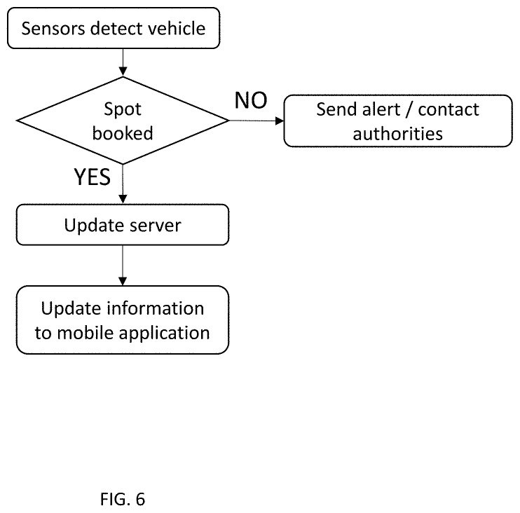

FIG. 6 illustrates a flowchart 600 for alerting a host of unauthorized parking according to the disclosed embodiments. The disclosed embodiments also may be used to monitor a parking spot to make sure unauthorized vehicles do not park in the spot. It also removes the need for law enforcement to continuously monitor public parking spots.

Step 602 executes by detecting a vehicle in the parking spot by a sensor. Server 102 may instruct the sensor to determine the presence of periodically. Alternatively, the sensor may “wake up” when a vehicle triggers it. Step 604 executes by determining whether the parking spot is booked, or reserved, for that time. If step 604 is no, then step 606 executes by sending an alert to the host or contacting the law enforcement authorities.

If step 604 is yes, then step 608 executes by updating server 102 that the booked spot has been filled. Server may verify the correct vehicle is in the spot, as disclosed above. Step 610 executes by updating the information for the parking spot to the application by server 102. Thus, the parking spot is not listed as available by the application.

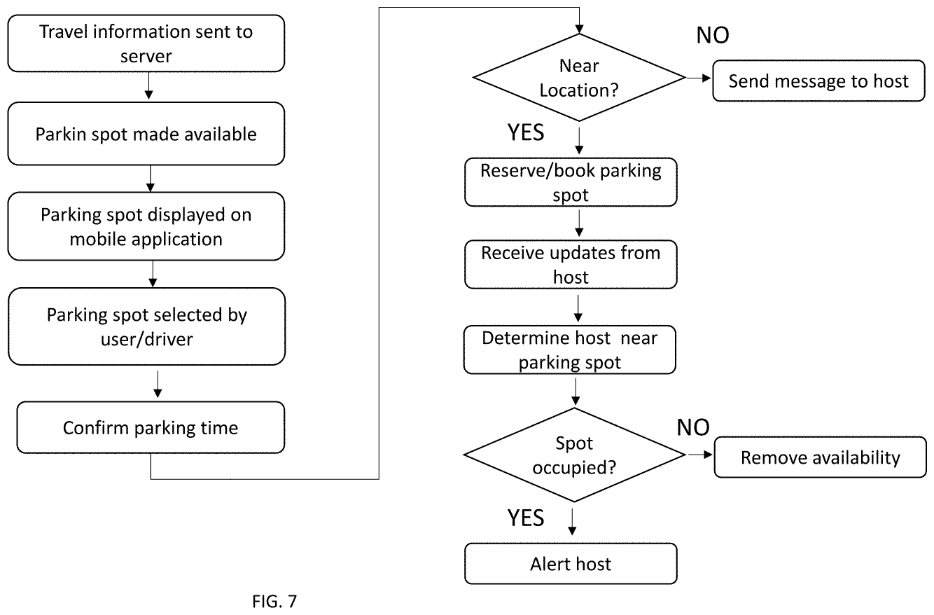

FIG. 7 illustrates a flowchart 700 for making a parking spot available using information from a vehicle according to the disclosed embodiments. In some embodiments, the parking spot availability may be updated using computing devices or systems operated by the host. These devices may link to server 102 to automatically update information from the host to make the parking spot available.

Step 702 executes by the host inputting travel information into a vehicle navigation system. For example, the host may input a request for a route from the parking spot in San Francisco to a location in Los Angeles. The navigation plots the route and determines the total travel time is about 5.5 hours. The navigation system may sync with the application on the mobile device to provide this information. In other embodiments, the host may plan a route in a computer that also syncs the information with the mobile device. Alternatively, the host may use a map or GPS application on the mobile device to provide the information.

Step 704 executes by sending the travel information to server 102. Server 102 then updates the records for the account linked to the parking spot and the host. Step 706 executes by making the parking spot available in the application. In the example, an 11 hour window may be opened to use the parking spot. This information is sent when requested by drivers 130. Thus, step 708 executes by displaying the parking spot availability in the application.

Step 710 executes by selecting the parking spot by the driver. In some embodiments, the driver may request times for parking in the spot. The travel times of the host are displayed to the driver. Step 712 executes by confirming the times selected by the driver.

Step 714 executes by determining whether the driver is near the location of the parking spot. If no, then step 716 executes by sending a message to the driver that the spot may not be available. If yes, then step 718 executes by booking the parking spot using the application, as disclosed above.

Step 720 executes by receiving updates at server 102 from the host of the parking spot. The navigation system may use its GPS capability to update server 102 at specified intervals. If the host hits traffic, then the trip may go from 11 hours to 15 hours. The disclosed embodiments can update the availability of the parking spot using this information.

Step 722 executes by determining that the host is near the parking spot. For example, the host may cut the trip short and return home. Yet, the parking spot may be reserved for the full estimated time of the trip. Thus, step 724 executes by determining whether the parking spot is available or reserved. If yes, then step 726 executes by alerting the host that the spot is taken. The host may communicate with the driver in the spot to see if the reservation period may be cut short for a refund. If step 724 is no, then step 728 executes by removing the availability of the parking spot from the application via server 102. The records for the parking spot are updated.

Parking Patterns and Artificial Intelligence

In some embodiments, the control detects parking patterns and determine a parking location, parking time, parking cost/price the user is willing to pay, and other parking related behaviors of the user. The control circuitry may use the parking patters to make parking predictions and provide information both the car owner as well as the parking space renter that may aid in determining parking solutions.

In determining a parking option, the control circuitry determines parking patterns as well as user recognition. The control circuitry may also determine a pattern where the user parks based on weather conditions, such as when it is raining or snowing or on a very hot day. For example, some car owners may prefer a certain type and location of parking, or a parking spot that provides easy access to the car, or other features that are suitable when the weather is bad or the weather is a certain way.

In some embodiments, the control circuitry, using the vehicle's global positioning system (GPS) may determine the parking location of the vehicle and determine that the parking location forms a parking pattern where the user usually parks their vehicle. In another embodiment, if the user owns an electric vehicle, the control circuitry may determine the parking spots that offer electric car charging capabilities

In another embodiment, the control circuitry may detect parking patterns such as parking locations based on parking history of the user. For example, if the user usually parks their car, which may be an electric car, and charges their electric vehicle in a covered parking garage, then the control circuitry may suggest parking spots that have shade, offer some cover to the car, and provide charging capabilities.

In some embodiment, the same car may be driven by multiple family members, or multiple friends, colleagues, or roommates. The control circuitry may store a user profile for each user that is authorized to use the car and determine their parking preferences. The control circuitry may store data from the detective patterns in the user profile such that when it detects the same user using the car, it can retrieve the pattern data from the profile and use it to determine the desired parking spot.

In one embodiment, an artificial intelligence or machine learning algorithm may be used to perform parking pattern detection and intelligibly use the algorithm to provide parking solutions. The algorithms may also be trained over time after having been applied to various parking situations to recognize the parking preferences for both the car owner and the renter of the parking spot.

The system automatically detects parking preferences, parking prices, parking locations, amenities offered at the parking spot, such as electric car charging, car wash, etc. and mechanisms, such as an artificial intelligence algorithm or other software, may be programmed to detect such parking details.

An artificial intelligence (AI) algorithm may be used by the system to determine the parking details and use them to provide solutions and suggestions. If a car owner owns an expensive car, the AI algorithm may determine the safety in the area where the parking is to be made and provide parking suggestions to the car owner. The AI algorithm may also provide suggestions to women or elderly on neighborhood safety, walking scores, and other details that will help them decide whether or not to park in the spot.

The data gathered through AI may be inputted into a machine learning algorithm. In one embodiment, the machine learning engine has instructions store therein that execute the machine learning algorithm. The machine learning engine gathers data over a period of time for each parking made and the machine learning algorithm is trained and refined and its probability and confidence level increase as more and more parking spots are rented and availed by the car owner. For example, if in 8 out of 10 times the owner parks in the cheaper spot even though they have to walk far to their destination, then the AI and machine learning algorithm may determine that price is the highest deciding criteria for the car owner.

Some pattern detection and parking solution offering embodiments include detecting, using a global positioning system, of a car, that the car is parked at a parking rental spot. In response to detecting that the car is parked at parking rental spot, determining whether the parking rental spot has been availed by the car owner. This ensures that the car is not just resting there for a few minutes or temporarily at a stop but in fact availing the rented spot.

In response to determining that the parking rental spot has been availed by the car owner, obtaining parking location data for the parking rented spot. This includes, the conditions surrounding the parking spot, such as busy road, shaded area, neighborhood safety, road and pavement conditions where the car is parked, e.g., does it have potholes, or condition of the road. Other parking details such as cost, amount of parking space, walking score from the car to stores may also be determined.

The parking details obtained are then compared with prior parking rental spots available by the user to detect a parking pattern. For example, the user may also prefer to park closer to a busy area and as such the walking score of areas parked are usually high or that car owner prefers to park only on spots that are well maintained and have wider parking spaces.

The patter is used to provide future parking rental suggestions based on a destination detected based on a route navigation system of the car. For example, if the system detects from the car navigation GPS that the car is headed to a certain desi nation, it may determine the availability of all parking spots that fit the pattern of parking and suggest only those that match.

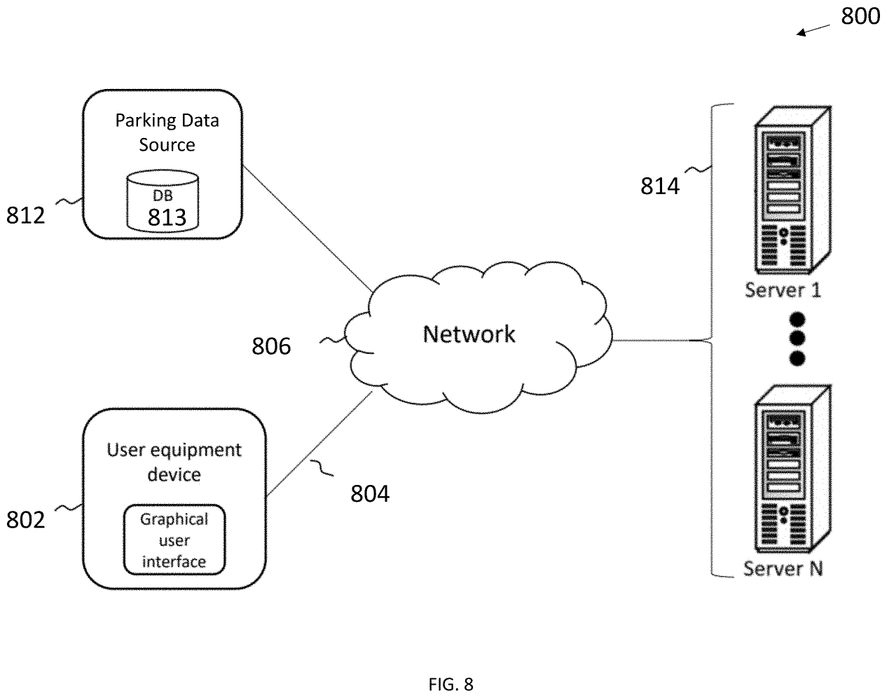

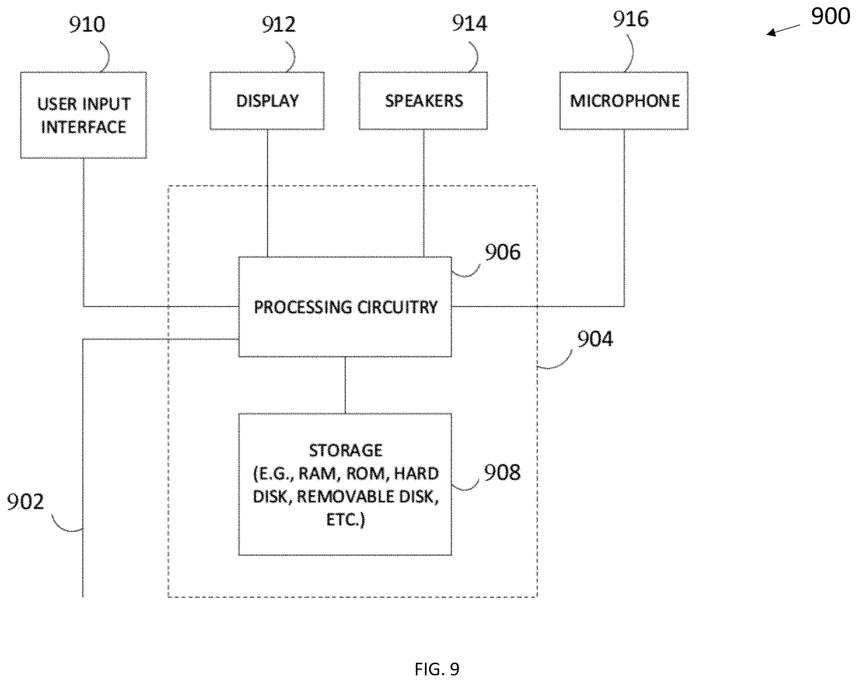

FIGS. 8-9 describe exemplary devices, systems, servers, and related hardware for determining parking spots, reserving parking spots, monitoring parking spots, providing details relating to a parking spot, managing host and user/driver platforms and interfaces relating to the parking spot reservations, and managing any hardware, such as key drop system and other services relating to parking and related car/vehicle services, such as cleaning, washing, maintenance etc., generating machine learning, and artificial intelligence algorithms, generating machine learning model based on user history, and executing all the processes described herein, in accordance with some embodiment of the disclosure.

Read Below and Remove Media Asset Etc

In the system 800, there can be more than one user equipment device 802 but only one is shown in FIG. 8 to avoid overcomplicating the drawing. In addition, a user may utilize more than one type of user equipment device and more than one of each type of user equipment device. In an embodiment there may be paths between user equipment devices, so that the devices may communicate directly with each other via communications paths, as well as other short-range point-to-point communications paths, such as USB cables, IEEE 1394 cables, wireless paths (e.g., Bluetooth, infrared, IEEE 802-11x, etc), or other short-range communication via wired or wireless paths. BLUETOOTH is a certification mark owned by Bluetooth SIG, INC. In an embodiment, the user equipment devices may also communicate with each other directly through an indirect path via the communications network 806.

The user equipment devices may be coupled to communications network 806. Namely, the user equipment device 802 is coupled to the communications network 806 via communications path 804. The communications network 806 may be one or more networks including the Internet, a mobile phone network, mobile voice or data network (e.g., a 4G, 5G, or LTE network), cable network, public switched telephone network, or other types of communications network or combinations of communications networks. The path 804 may separately or in together with other paths include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In one embodiment path 804 can be a wireless path. Communication with the user equipment device may be provided by one or more communications paths but is shown as a single path in FIG. 8 to avoid overcomplicating the drawing.

The system 800 also includes parking data sources, such as parking data sources 812, and one or more servers 814, which can be coupled to any number of databases providing information to the user equipment devices. The information sources 812 represent any computer-accessible sources, such as servers, databases, platforms (such as video sharing platforms) that store media assets, such as video assets. The server 814 may store and execute various software modules, such as for example for determining parking locations, determining parking spot availability, determining parking related preferences, determining parking payment options, parking prices, real time parking spot reservations, parking management solutions, walking scores and distance between parking locations and points of interests as well as shopping areas, processing of QR codes relating to parking, parking location attributes and conditions, parking lock and key lock box management, user interface communications for host to mark their parking spot as available or not available, calendaring related to parking, and management of ratings of paring spot, parking host as well as driver/user ratings. The server 814 may also store and execute various software modules to graphically display parking related information, or allow the user, driver, or host to interact with the system, with each other, and the lock box using user interfaces from their mobile, laptop, and other computing devices. Machine learning, and artificial intelligence algorithms, generating machine learning model based on user consumption history, and transmitting the instructions to a parking data source systems may also be performed by the server by executing various software modules. In some embodiments, the server may transmit a command to cause the display of a user interface on the display screen of a media asset device or a user's mobile device. The user interface may be used by the user to select preferences, execute commands, and approve or reject various options, such as approve a parking reservation, allow access to a lock box, collect or process payment, provide calendar for booking the parking spot.

FIG. 9 shows a generalized embodiment of a user equipment device 900, in accordance with one embodiment. In an embodiment, the user equipment device 900, is the same user equipment device 802 of FIG. 8. The user equipment device 900 may receive content and data via input/output (I/O) path 902. The I/O path 902 may provide content (e.g., parking availability, parking location data, parking prices, calendar of parking on a private property) and data to control circuitry 904, which includes processing circuitry 906 and a storage 908. The control circuitry 904 may be used to send and receive commands, requests, and other suitable data using the I/O path 902. The I/O path 902 may connect the control circuitry 904 (and specifically the processing circuitry 906) to one or more communications paths. I/O functions may be provided by one or more of these communications paths but are shown as a single path in FIG. 9 to avoid overcomplicating the drawing.

The control circuitry 904 may be based on any suitable processing circuitry such as the processing circuitry 906. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Analyzing parking availability, reserving parking spots, determining parking locations, determining parking related preferences, determining parking payment options, parking prices, real time parking spot reservations, parking management solutions, walking scores and distance between parking locations and points of interests as well as shopping areas, processing of QR codes relating to parking, determining parking location attributes and conditions, managing parking lock and key lock box management, providing user interface communications for host to mark their parking spot as available or not available, calendaring related to parking, and management of ratings of paring spot, parking host as well as driver/user ratings, using machine learning, and artificial intelligence algorithms, generating machine learning model based on user consumption history and executing all the processes described herein can be at least partially implemented using the control circuitry 904. The processes as described herein may be implemented in or supported by any suitable software, hardware, or combination thereof. They may also be implemented on user equipment, on remote servers, or across both.

In client-server-based embodiments, the control circuitry 904 may include communications circuitry suitable for communicating with one or more servers that may at least implement the storing of the parking availability, parking reservation information, data relating to the host and or the user/driver, parking prices, and other feature mentioned above, including scores relating to attributes, user profiles of drivers, family members and authorized circles, machine learning and artificial intelligence programs, and related functions and processes as described herein. The instructions for carrying out the above-mentioned functionality may be stored on the one or more servers. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 908 that is part of the control circuitry 904. As referred to herein, the phrase “electronic storage device” or “storage device” should be understood to mean any device for storing electronic data, computer software, or firmware, such as random-access memory, read-only memory, hard drives, optical drives, solid-state devices, quantum storage devices, or any other suitable fixed or removable storage devices, and/or any combination of the same. The storage 908 may be used to store various types of content described herein. Nonvolatile memory may also be used (e.g., to launch a boot-up routine and other instructions). Cloud-based storage, described in relation to FIG. 8, may be used to supplement the storage 908 or instead of the storage 908.

The user equipment device 900 may include an interface 910. The interface 910 may be any suitable user interface, such as a remote control, mouse, trackball, keypad, keyboard, touch screen, touchpad, stylus input, or other user input interfaces. A display 912 may be provided as a stand-alone device or integrated with other elements of the user equipment device 900. For example, the display 912 may be a touchscreen or touch-sensitive display. When the interface 910 is configured with a screen, such a screen may be one or more of a monitor, a liquid crystal display (LCD) for a mobile device, active matrix display, light-emitting diode display, organic light-emitting diode display, quantum dot display, or any other suitable equipment for displaying visual images related to parking reservations, management, solutions, or attributes. In some embodiments, the display 912 may be a 3D display. The speaker (or speakers) 914 may be provided as integrated with other elements of user equipment device 900 or may be a stand-alone unit. In some embodiments, the display 912 may be outputted through speaker 914.

The user equipment device 900 of FIG. 9 can be implemented in system 800 of FIG. 8 as user equipment device 802, but any other type of user equipment suitable for determining parking locations, determining parking spot availability, determining parking related preferences, determining parking payment options, parking prices, real time parking spot reservations, parking management solutions, walking scores and distance between parking locations and points of interests as well as shopping areas, processing of QR codes relating to parking, parking location attributes and conditions, parking lock and key lock box management, user interface communications for host to mark their parking spot as available or not available, calendaring related to parking, and management of ratings of paring spot, parking host as well as driver/user ratings. It may also be implemented in system 800 as user equipment device 802, but any other type of user equipment suitable for executing the functions and processes described herein. Various network configurations of devices may be implemented and are discussed in more detail below.

It will be apparent to those skilled in the art that various modifications and variations can be made in the disclosed embodiments of the disclosed device and associated methods without departing from the spirit or scope of the invention. Thus, it is intended that the present invention covers the modifications and variations of the embodiments disclosed above provided that the modifications and variations come within the scope of any claims and their equivalents.

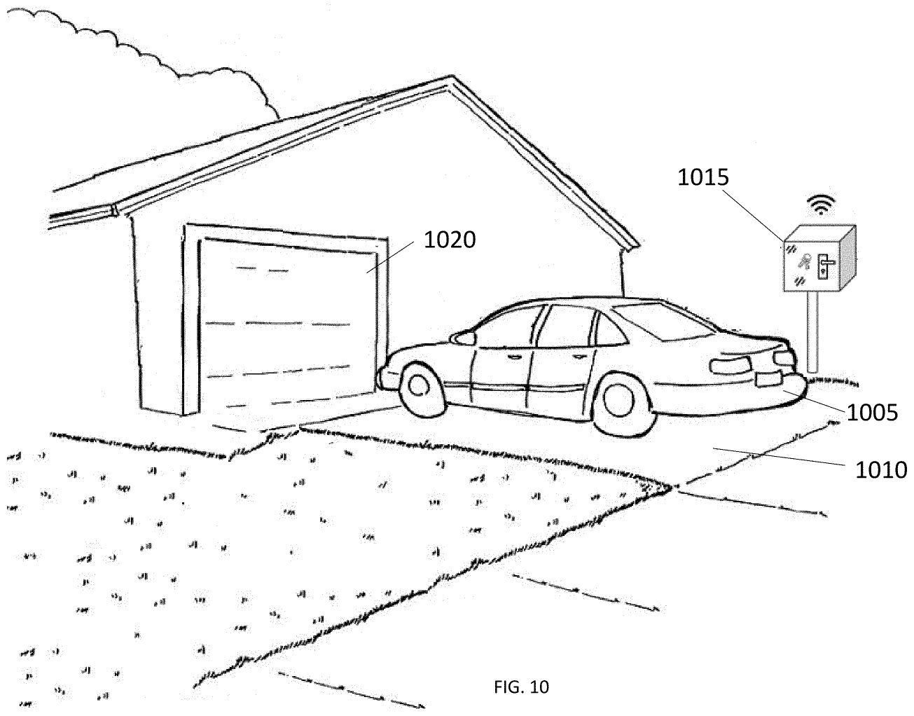

FIG. 10 is an exemplary figure of a car parked in a driveway of a host that includes a lock box for the keys according to one embodiment. As depicted, the car 1005 is parked in a driveway 1010 that has a lock box 1015. Although the car is shown parked in the driveway, it may also be parked inside a garage 1020 of the host if the host allows that as a parking spot.

The lock box 1015 may be operated by a lock and key, a lock punch in code, or a wife signal to open and lock the lock box. In other embodiments, no keys may be required for the car and a Wi-Fi signal or another remote authorized technique may be used to authorize those allowed to operate the car, such as the car owner, host, or another parking spot renter who may have to move your car in order to park their own car. The driveway or garage may host more than one car and the access codes for the lockbox may be same or different for each renter. The host of the parking spot may also use code changing techniques that change the code automatically every few seconds and require an authenticator, such as Google authenticator™ to obtain the code.

The lock box may be see through glass or may be of another kind that is does not allow visibility of contents inside. In some embodiments, the lock box may include an alert or a direct connection to a police or local authorities to alert them in case of tampering or attempt of a theft. The lock box may also include a camera inside and a camera outside to monitor the inside and the surrounding whose live video feed may be accessed by an authorized user to their mobile phone or a monitor. Such a fee may also be sent to a police department to provide details of the tampering or the perpetrator.

In some embodiments, the camera on the lock box may be positioned to monitor the car. The camera may be movable and a video feed may be accessed by an authorized user. The system may also program the camera such that every periodic interval a snapshot of the car and or the contents of the lock box are provided to an authorized user or stored to memory.

In some embodiments, the driveway or the garage may include parking spot sensors, such as internet of things (IOT) sensors. The sensors may be used to monitor if a car is parked in a specific location and also used to detect if the car has been moved. The sensors may project a light or use another mechanism to sense the proximity of an object above them to confirm whether a car is parked above a sensor location. The sensors may also be included, such as above the car, over or towards the top of a garage, on a lamppost, the structure of the home where the car is parked to monitor the car as well.

In some embodiments, the sensors are used to detect weather changes, such as it is snowing or raining. The system may be configured to provide such data to the user or the host such that the user may take any necessary steps. For example, the host may move the car into a garage if snow conditions are detected to protect the car. The system may also access a local weather monitoring and reporting system or internet source in response to the detection of the weather change to determine the details of the weather and provide them to the user. For example, in some embodiments, if prior user have reported that due to heavy rainfall or snow, this particular parking spot of its local streets are effected, such as flooded or hard to get out, then the system may access such prior parking experiences and report them to the renter such that the renter may decide to take appropriate actions.

In some instances, when it is a remotely operable electric car, the renter may also move the car within the allowed parking areas on the facility due to a weather change or for any other reason.

The artificial intelligence algorithms may also determine weather and other locale condition changed, access internet and other local reporting sources in response to the changes, and provide suggestions to the renter. For example, the AI algorithm may determine weather changes, determine that the street will be flooded and inform the renter. It may also determine that a snow truck will pass by blocking the driveway and inform the user. The AI algorithm may obtain such information from local system. The AI algorithm may also monitor local system and crowd sourcing information system to determine any changes in the local area, for example, if a riot breaks out, a rally is occurring, a theft has happened in the neighborhood, then the AI algorithm may determine the occurrence and provide suggestions to the renter.

In some embodiments, the systems and methods described may provide a marketplace for parking spot renters and host to host a parking spot, rent the parking spot, and perform all parking related management services, such as collecting payment, providing information related to the parking, monitoring the car and the local conditions etc.

It is contemplated that some suitable steps or suitable descriptions of FIGURES depicted above may be used with other suitable embodiments of this disclosure. In addition, some suitable steps and descriptions described in relation to th above mentioned figures may be implemented in alternative orders or in parallel to further the purposes of this disclosure. For example, some suitable steps may be performed in any order or in parallel or substantially simultaneously to avail parking and provide a parking marketplace. Furthermore, it should be noted that some suitable devices or equipment discussed in relation to FIGS. 1, 8, and 9 could be used to perform one or more of the steps in the flowcharts.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A computer-implemented method for parking reservations and parking management comprising:
generating a user interface on a display device that provides selectable options to determine a parking spot in a non-commercial parking space;
receiving a request for a parking spot through a selection made using the user interface;
in response to receiving the selection:
calculating a threshold radius from the current location of the vehicle to determine an available parking spot, wherein determining an available parking spots comprises:
querying either an electric box or a parking spot sensor to determine space availability; and
in response to receiving a spot availability indication from the electric box or the parking spot sensor, accessing the schedule for the parking spot to determine the schedule of availability;
displaying one or more available parking spots within the radius; and
displaying an option to book the one or more available parking spot for a period of time within available window of time for the parking spot determined by the accessed schedule.

2. The method of claim 1, wherein displaying one or more available parking spots is in response to determining that a) the parking spot is available and b) that it is available for an amount of time that a user of a vehicle intends to park the vehicle in the parking spot.

3. The method of claim 2, further comprising:
in response to determining that the parking spot is available for a lesser amount of time that the time intended by the user to park the vehicle, sending a message to the user informing them of the lesser amount of time available and providing a selection on the user interface for the user to select reserving the spot for the lesser amount of time.

4. The method of claim 1, further comprising:
receiving a booking confirmation selection from the user interface; and
booking the spot for user associated with the booking confirmation.

5. The method of claim 4, further comprising:
sending parking information to the user that booked the parking spot.

6. The method of claim 5, wherein, the parking information includes directions to the parking spot.

7. The method of claim 1, further comprising, obtaining parking parameters of the parking spot once it is availed by a car owner.

8. The method of claim 7, wherein the parking parameters include: condition of the parking spot, traffic near the parking spot, walking score from the parking spot, price of the parking spot, and neighborhood safety of the parking spot.

9. The method of claim 7, further comprising, providing parking spot suggestions based on the parking parameters obtained.

10. A computer-implemented method comprising:
detecting, using a global positioning system, of a car, that the car is parked at a parking rental spot;
in response to detecting that the car is parked at parking rental spot:
determining whether the parking rental spot has been availed by the car owner; and
in response to determining that the parking rental spot has been availed by the car owner:
obtaining parking location data for the parking rented spot;
comparing the parking location data with parking data from prior parking rental spots availed by the user to detect a parking pattern; and
using the detected pattern to provide future parking rental suggestions.

11. The computer-implemented method of claim 10, wherein, future parking rental suggestions are provided in response to detecting a destination inputted in a route navigation system of the car.

12. The computer-implemented method of claim 10, further comprising processing a QR code presented at the parking rental spot to validate the parking of the car.

13. The computer-implemented method of claim 10, wherein the parking location data includes information selected from a group consisting of condition of the parking spot, traffic near the parking spot, walking score from the parking spot, price of the parking spot, and neighborhood safety of the parking spot.

14. The computer-implemented method of claim 10, wherein the parking pattern is detected using a machine learning algorithm.

15. The computer-implemented method of claim 14, further comprising, training the machine learning algorithm based over time based on the parking rental spots availed by the user.

16. A system for parking reservations and parking management comprising:
communications circuitry to access a parking spot electric box or a parking spot sensor; and
control circuitry configured to;
generate a user interface on a display device that provides selectable options to determine a parking spot in a non-commercial parking space;
receive a request for a parking spot through a selection made using the user interface;
in response to receiving the selection:
calculate a threshold radius from the current location of the vehicle to determine an available parking spot, wherein determining an available parking spots comprises:
querying either an electric box or a parking spot sensor to determine space availability; and
in response to receiving a spot availability indication from the electric box or the parking spot sensor, accessing the schedule for the parking spot to determine the schedule of availability;
displaying one or more available parking spots within the radius; and
displaying an option to book the one or more available parking spot for a period of time within available window of time for the parking spot determined by the accessed schedule.

17. The system of claim 16, wherein the control circuitry is configured to display one or more available parking spots is in response to determining that a) the parking spot is available and b) that it is available for an amount of time that a user of a vehicle intends to park the vehicle in the parking spot.

18. The system of claim 17, further comprising, the control circuitry configured to:
in response to determining that the parking spot is available for a lesser amount of time that the time intended by the user to park the vehicle, send a message to the user informing them of the lesser amount of time available and providing a selection on the user interface for the user to select reserving the spot for the lesser amount of time.

19. The system of claim 16, further comprising, the control circuitry configured to:
receive a booking confirmation selection from the user interface; and
book the spot for user associated with the booking confirmation.

20. The system of claim 19, further comprising, the control circuitry configured to:
send parking information to the user that booked the parking spot.
